(19) United States
(12) Patent Application Publication
(10) Pub. No.: US 2005/0275353 A1
(43) Pub. Date: Dec. 15, 2005

(54) Circuit for the operation of light sources

(75) Inventors: Felix Franck, Munchen (DE); Helmut Haeusser-Boehm, Munchen (DE)

Correspondence Address: OSRAM SYLVANIA INC, 100 ENDICOTT STREET, DANVERS, MA, 01923, US

(73) Assignee: PATENT-TREUHAND - GESELLSCHAFT FUR ELEKTRISCHE GLUHLAMPEN MBH, MUNCHEN (DE)

(21) Appl. No.: 11/147,210

(22) Filed: Jun. 8, 2005

(30) Foreign Application Priority Data
Jun. 15, 2004 (DE) 10 2004 028 799.6

(51) Int. Cl. H05B 37/02

(52) U.S. Cl. 315/209 R

(57) ABSTRACT

An electronic transformer for halogen incandescent lamps is equipped with a self-commutated half-bridge inverter. The half-bridge inverter contains a start circuit with a start capacitor (C3), which starts commutation of the half-bridge inverter after each mains half-wave by driving a lower half-bridge transistor (T2). The start circuit has to be suppressed while the half-bridge inverter is commutating. This is achieved according to the invention by discharging the start capacitor (C3) whenever an upper half-bridge transistor is turned on (T1). This is done by an amplifier element (V1), which is driven via a high-pass filter (C4) from the half-bridge midpoint (M).

### TECHNICAL FIELD

The invention relates toga circuit for the operation of light sources. The invention relates in particular to half-bridge inverters for the operation of halogen incandescent lamps.

### BACKGROUND OF THE INVENTION

Half-bridge inverters are widely known for the operation of light sources. The half-bridge inverter is fed with a supply voltage, which is a DC voltage. For light sources whose light flux responds only slowly to the electrical energy provided, the DC voltage may be pulsed without impairing the quality of the light. Halogen incandescent lamps represent such a light source. Half-bridge inverters for halogen discharge lamps are therefore generally fed with a rectified mains voltage as the supply voltage, without any smoothing being provided.

It is also widely known that half-bridge inverters for halogen incandescent lamps are embodied as self-commutated inverters for cost reasons. In this context, self-commutated means that a drive signal for electronic switches of the half-bridge is taken from an output circuit. In what follows, the term half-bridge inverter is always intended to mean a self-commutated half-bridge inverter. It consists essentially of the series circuit of an upper electronic switch and a lower electronic switch, which are joined at a half-bridge midpoint and are connected between a supply voltage and a ground potential.

The commutation of the half-bridge inverter has to be started by a start circuit. This is necessary after each mains half-wave since the commutation is broken off when there is a low instantaneous mains voltage. The start circuit consists essentially of a start capacitor and a trigger element. As soon as the voltage at the start capacitor exceeds a trigger threshold, a start pulse is initiated; this means that the trigger element connects the start capacitor to the control electrode of the lower electronic switch. The lower electronic switch is therefore turned on and the commutation of the half-bridge inverter commences. The start capacitor must deliver enough energy for the lower electronic switch to remain reliably turned on for long enough.

Once the half-bridge inverter is commutating, it is necessary to ensure that no further start pulses arrive from the start circuit, since these would perturb the commutation in progress. In fact, a start pulse while the upper electronic switch is turned on would actually destroy the half-bridge since a so-called cross current is set up.

A solution to this problem is proposed in EP 0 682 464 (Lecheler). A switching transistor is connected by its working electrodes in parallel with the start capacitor, and is driven by the control signal of the lower electronic switch. In the prior art, the start capacitor is thus always discharged when the lower electronic switch is being driven. As long as the half-bridge inverter is commutating, this prevents the voltage at the start capacitor from reaching a value which sends a start pulse via the trigger element.

In the circuit described in the prior art, there is a problem at the start of the commutation of the half-bridge. Precisely when the start capacitor is intended to deliver enough energy to drive the lower electronic switch, the described switching transistor is driven and draws energy from the start capacitor. Reliable starting of the commutation of the half-bridge inverter is therefore not guaranteed.

### SUMMARY OF THE INVENTION

It is an object of the present invention to provide a half-bridge inverter for the operation of light sources, the commutation of which is started reliably.

This object is achieved by a circuit for the operation of light sources which contains an amplifier element having an input and an output. Without restriction of generality, it is assumed that the potentials at the input and at the output are relative to the ground potential. The output of the amplifier element is joined to a start capacitor which is likewise grounded. If a positive signal is applied to the input of the amplifier element, then the start capacitor is discharged.

According to the invention, the signal at the input of the amplifier element is generated from the half-bridge midpoint via a highpass filter. When there is a leading edge at the half-bridge midpoint, the high pass filter generates a positive signal at the input of the amplifier element. The start capacitor is thereby discharged according to the invention whenever the upper electronic switch and not the lower electronic switch is turned on. As explained above, the start of the commutation of the half-bridge inverter is initiated by a start pulse at the lower electronic switch. In the present invention, the start capacitor is not discharged for this starting procedure, which facilitates reliable starting of the half-bridge inverter.

### BRIEF DESCRIPTION OF THE DRAWINGS

The invention will be explained in more detail below with the aid of exemplary embodiments with reference to the drawings, in which:

FIG. 1 shows an exemplary embodiment of a circuit according to the invention for the operation of light sources,

FIG. 2 shows another exemplary embodiment of a circuit according to the invention for the operation of light sources,

FIG. 3 shows another exemplary embodiment of a circuit according to the invention for the operation of light sources,

FIG. 4 shows an exemplary embodiment of an amplifier element as used in the invention,

FIG. 5 shows another exemplary embodiment of an amplifier element as used in the invention,

FIG. 6 shows another exemplary embodiment of an amplifier element as used in the invention,

FIG. 7 shows another exemplary embodiment of an amplifier element as used in the invention,

In what follows, resistors will be denoted by the letter R, transistors by the letter T, amplifier elements by the letter V, diodes by the letter D, capacitors by the letter C, in each case followed by a number. Furthermore, the same references will be used in what follows for elements which are the same and have the same effect throughout the various exemplary embodiments.

### DETAILED DESCRIPTION OF THE INVENTION

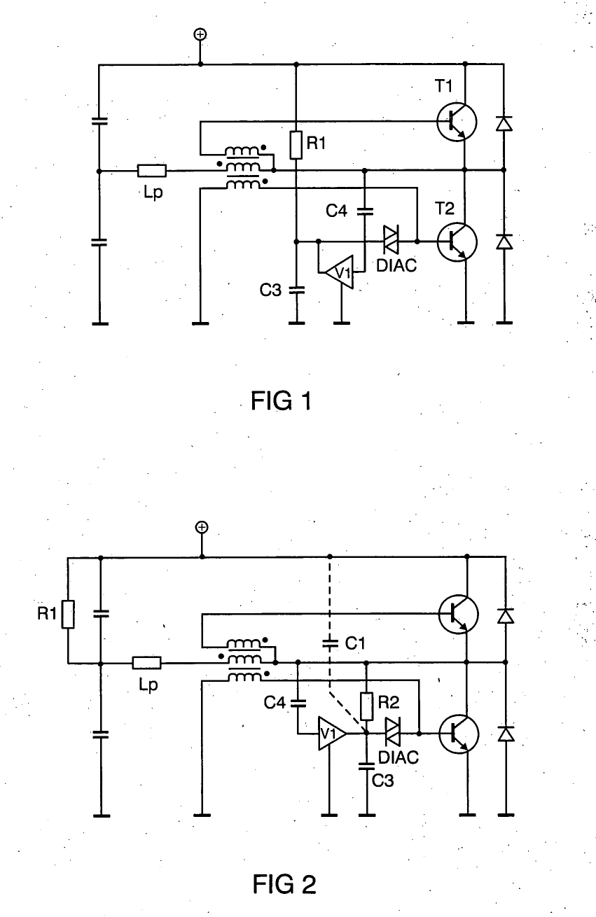

FIG. 1 represents an exemplary embodiment of a circuit according to the invention for the operation of light sources. The series circuit of an upper electronic switch T1 and a lower electronic switch T2 is connected between a terminal for a supply voltage, which is denoted by a +sign, and a ground potential. The interconnection node M forms a half-bridge midpoint. The electronic switches are presented as NPN bipolar transistors. It is nevertheless possible to use other electronic switches, for example MOSFETs or IGBTs. An optional freewheel diode is respectively depicted in parallel with each electronic circuit.

The series circuit of two coupling capacitors C11 and C12 is connected in parallel with the series circuit of T1 and T2. The half-bridge inverter, which consists essentially of T1, T2, C11 and C12, delivers an AC voltage of high frequency compared with a mains voltage between the interconnection point of C11 and C12 and the half-bridge midpoint M. The series circuit of the primary winding of a feedback transformer Tr and a load is connected to this AC voltage. One coupling capacitor C11 or C12 may be omitted.

The load is represented by a resistor with the reference Lp. In the simplest case, the load may consist merely of an incandescent lamp. Alternatively, low-voltage halogen incandescent lamps may be connected up via a transformer.

By the primary winding, the feedback transformer Tr picks up a load current and couples it back via two secondary windings respectively to control electrodes of T1 and T2. A feedback circuit is thereby closed, so that a self-commutated half-bridge inverter is obtained.

A start circuit is formed by a start capacitor C3, a resistor R11 and a trigger element DIAC. C3 and R11 are connected in series between the supply voltage and the ground potential. The DIAC joins the interconnection point of C3 and R11 to the control electrode of the lower electronic switch T2. Via R11, C3 is charged with the supply voltage. If the voltage reaches a value which is more than the threshold voltage of the DIAC, i.e. typically 33 V, then C3 sends a start pulse to the control electrode of T2.

According to the invention, the circuit contains an amplifier element V1 which is grounded in FIG. 1. An output of V1 is joined to C3. An input of V1 is joined according to the invention via a highpass filter to the half-bridge midpoint M. In the exemplary embodiment according to FIG. 1, the highpass filter is formed by a highpass capacitor C4.

If the voltage at the half-bridge midpoint M rises, then C4 generates a positive voltage at the input of V1. V1 thereupon discharges the start capacitor C3 via its output, so that further start pulses are prevented. When the lower electronic switch T2 switches on, there is a negative signal at the input of V1. This actively stops discharge of C3. Until the next time of the upper electronic switch T1 is turned on, C3 is charged only slightly. The threshold voltage of the trigger element DIAC is not reached during this time.

The resistor R1 has a typical value of 330 kohm and the highpass capacitor C4 has a typical value of 10 nF. FIG. 2 represents a modified variant of the exemplary embodiment in FIG. 1. Compared with FIG. 1, the resistor R11 in FIG. 2 is divided into a first resistor R1 and a second resistor R2. R2 joins the start capacitor C3 to the half-bridge midpoint M, while R1 joins the half-bridge midpoint M to the supply potential. In the example, this is done via the load and the primary winding of the feedback transformer Tr. R1 and R2 typically have a value of 220 kohm each. Compared with the variant in FIG. 1, the power loss of the resistors can therefore be reduced. Furthermore, the start capacitor C3 is charged more slowly when the half-bridge is turned off. This entails a smaller number of start pulses per unit time, which reduces the component loading and the quiescent current consumption of the circuit.

In FIG. 2, an acceleration capacitor C1 joins the start capacitor C3 to the supply voltage. Faster initiation of a start pulse after a mains voltage zero crossing is thereby achieved. If the supply voltage has a sufficiently high AC component, then the acceleration capacitor C1 on its own is enough for charging the start capacitor C3 to the threshold value of the trigger element DIAC. The resistors R1 and R2 or R11 may then be omitted. There is a high AC component of the supply voltage whenever a sinusoidal mains voltage is rectified by a full-bridge rectifier and is not smoothed. There is also a high AC component of the voltage supply when the circuit is operated in a trailing edge or leading edge phase dimmer.

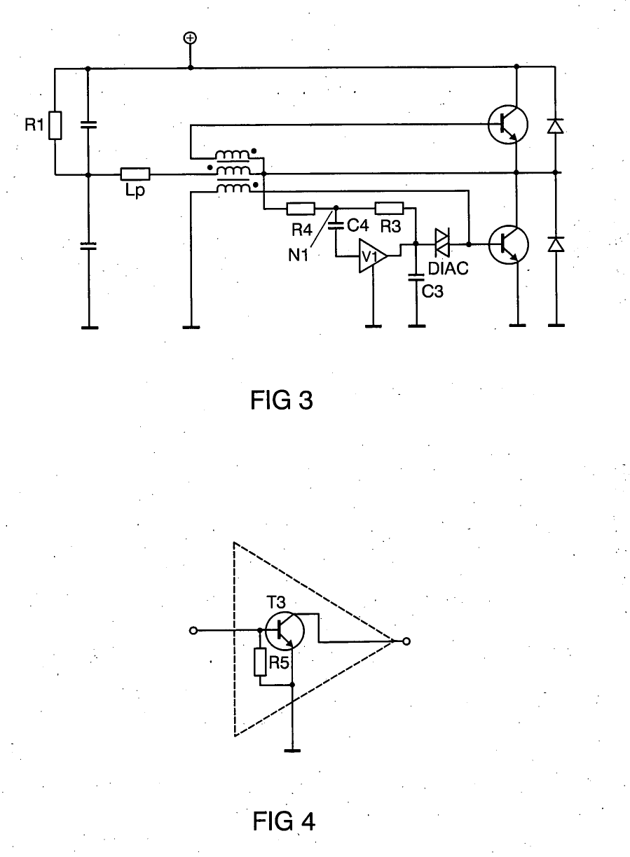

FIG. 3 represents another exemplary embodiment of a circuit according to the invention. Compared with the exemplary embodiment in FIG. 2, the second resistor R2 is divided into the series circuit of a third resistor and a fourth resistor R3, R4. There is a first interconnection point N1 between R3 and R4. The highpass capacitor C4 is not joined directly to the half-bridge midpoint M, but is attached to the interconnection point N1 and therefore joined via R4 to the half-bridge midpoint M. Through the ratio of R3 to R4, the characteristic of the highpass filter consisting of R4 and C4 can be adjusted independently of the sum of the resistors R3 and R4. Typical values are:

C1: 3.3 nF; C3: 10 nF; C4 22 nF; R3: 75 kohm; R4: 75 kohm.

FIG. 4 represents an exemplary embodiment of an amplifier element V1 as used in the invention. The example in FIG. 4 represents the simplest example for V1. An NPN bipolar transistor T3 has its emitter terminal at the ground potential. The base forms the input of the amplifier element, and the collector forms the output of the amplifier element. A resistor R5, which typically has a value of 470 ohms, is connected between the base and emitter. If a positive signal is applied to the input, then the transistor T3 is driven and discharges the start capacitor C3 via its collector.

FIG. 5 represents another exemplary embodiment of an amplifier element V1 as used in the invention. The example in FIG. 4 has been expanded in FIG. 5 by the diodes D1 and D2. The input of the amplifier element is joined via D2 to the base of T3 and via D1 to the ground potential. The switching properties of T3 are thereby improved.

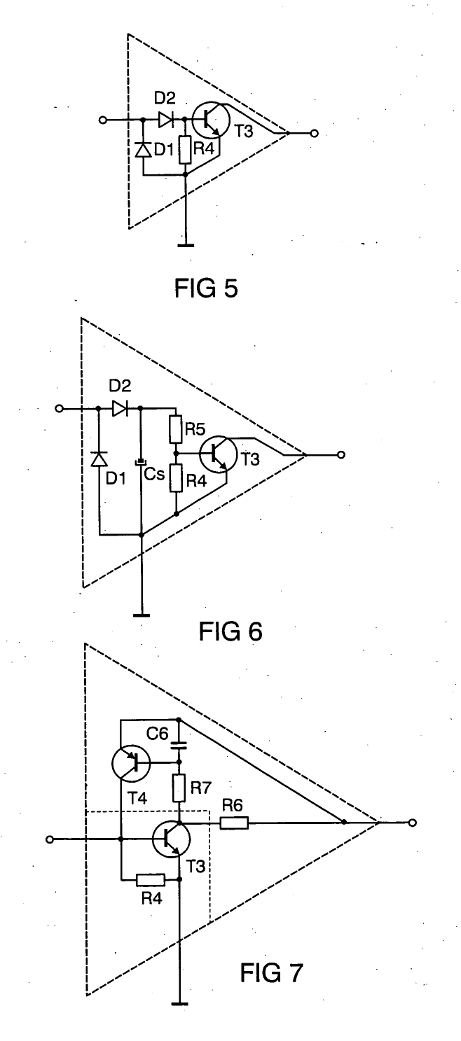

FIG. 6 represents another exemplary embodiment of an amplifier element V1 as used in the invention. The example in FIG. 5 has been expanded in FIG. 6 by the resistor R5 and the capacitor C5. R5 and C5 form a delay device. R5 is connected in series with D2, and C5 joins D2 to the ground potential. The effect achieved by this delay device is that the start capacitor C3 is discharged not immediately when a signal is applied to the input of the amplifier element, but only when C5 has been charged. This can be important for suppressing spurious signals. The delay device can furthermore be employed for using the amplifier element in conjunction with a switch-off in case of a fault.

FIG. 7 represents another exemplary embodiment of an amplifier element V1 as used in the invention. The example in FIG. 4 has been expanded in FIG. 7 by a latching device. The collector of T3 is now joined via a resistor R6 to the output of the amplifier element. The latching element is formed by the resistor R7, the capacitor C6 and the PNP transistor T4. The series circuit of R7 and C6 is connected in parallel with R6. The collector of T4 is joined to the base of T3, and the collector of T3 joined via R7 to the base of T4. The emitter of T4 is joined to the output of the amplifier element. The interconnection of T3 and T4 in the manner described is described as a thyristor emulation. As soon as T4 conducts, the thyristor engages and does not switch off again until a holding current, which is delivered by C3, falls below a holding current threshold. The engagement of the thyristor is delayed by C6. If C6 is replaced by a resistor, the thyristor engages without delay.

The effect of the latching property of the amplifier element is that the half-bridge inverter is switched off as soon as a positive signal is applied to the input of the amplifier element for long enough. This may be used for switching off in case of a fault, for example short circuit at the load. For restarting, the circuit has to be briefly disconnected from the supply voltage.

The delay device of FIG. 6 may also be combined with a latching device of FIG. 7.

1. A circuit for the operation of light sources, having the following features:
a self-commutated half-bridge inverter having a series circuit of an upper electronic switch and a lower electronic switch (T1, T2), which are joined at a half-bridge midpoint (M) and are connected between a supply voltage (+) and a ground potential,
a start capacitor (C3) which is joined via a trigger element (DIAC) to a control electrode of the lower electronic switch (T2), and
an amplifier element (V1) having an input and an output, the output being joined to the start capacitor (C3) so that it discharges the start capacitor (C3) if a signal is applied to the input of the amplifier element (V1),
wherein the input of the amplifier element (V1) is joined via a highpass filter (C4, R4) to the half-bridge midpoint (M).

2. The circuit for the operation of light sources as claimed in claim 1,
characterized in that the highpass filter is a highpass capacitor (C4).

3. The circuit for the operation of light sources as claimed in claim 1, characterized in that the half-bridge midpoint (M) is joined via a first resistor (R1) to the supply voltage (+) and the start capacitor (C3) is joined via a second resistor (R2) to the half-bridge midpoint (M).

4. The circuit for the operation of light sources as claimed in claim 3, characterized in that the second resistor (R2) is formed by the series circuit of a third resistor and a fourth resistor (R3, R4), there being a first interconnection point (N1) and a highpass capacitor (C4) being connected between the first interconnection point (N1) and the input of the amplifier element (V1).

5. The circuit for the operation of light sources as claimed in claim 1, characterized in that the start capacitor (C3) is joined via an acceleration capacitor (C1) to the supply voltage (+).

6. The circuit for the operation of light sources as claimed in claim 1, characterized in that the amplifier element (V1) contains a first transistor (T3) having two working electrodes and a control electrode, one working electrode being joined to the output of the amplifier element (V1) and one being joined to the ground potential, and the control electrode furthermore being connected to the input of the amplifier element (V1) and a fifth resistor (R5) furthermore being connected between the control electrode and the ground potential.

7. The circuit for the operation of light sources as claimed in claim 6, characterized in that a first diode (D1) is connected between the input of the amplifier element (V1) and the ground potential.

8. The circuit for the operation of light sources as claimed in claim 6, characterized in that a second diode (D2) is connected between the input of the amplifier element (V1) and the control electrode.

9. The circuit for the operation of light sources as claimed in claim 6, characterized in that a delay device (R5, C5), which delays driving of the first transistor (T3) for a predetermined time, is connected between the input of the amplifier element (V1) and the control electrode.

10. The circuit for the operation of light sources as claimed in claim 6, characterized in that the amplifier element (V1) contains a latching device (T4, R7, C6), so that the start capacitor (C3) remains discharged even when the amplifier element (V1) is not being driven at its input.

11. The circuit for the operation of light sources as claimed in claim 7, characterized in that a second diode (D2) is connected between the input of the amplifier element (V1) and the control electrode.
